(19) United States
(12) Patent Application Publication
(10) Pub. No.: US 2017/0080543 A1
(43) Pub. Date: Mar. 23, 2017

(54) ADDITIVE MANUFACTURE OF INTERIOR PASSAGES

(71) Applicant: Delavan Inc, West Des Moines, IA (US)

(72) Inventor: Thomas J. Ocken, Des Moines, IA (US)

(73) Assignee: Delavan Inc, West Des Moines, IA (US)

(21) Appl. No.: 14/860,797

(22) Filed: Sep. 22, 2015

(51) Int. Cl. B24B 31/00; B29C 67/00

(52) U.S. Cl. CPC B24B 31/006; B29C 67/0051; B33Y 10/00

(57) ABSTRACT

A method of additive manufacturing includes additively forming a workpiece. The workpiece defines an interior passage therethrough with a passage surface. Additively forming the workpiece includes additively forming a beam running through the interior passage spaced apart from the passage surface. The method also includes surface treating the passage surface using abrasive flow machining wherein an abrasive flow machining fluid is forced to flow between the beam and the passage surface. The beam can be removed from the workpiece after surface treating the passage surface.

### BACKGROUND OF THE INVENTION

1. Field of the Invention

The present disclosure relates to additive manufacturing, and more particularly to surface finishing internal passages in additive manufactured components such as used in fuel injectors for gas turbine engines.

2. Description of Related Art

The surface roughness in additive manufactured parts is typically greater than in machined or cast parts. Many components produced with additive manufacturing require surface treatment for key surfaces, such as interior flow passages in fuel injectors, due to the limited surface finish attainable in typical additive manufacturing processes. Exterior surfaces can be surface finished using conventional surface finishing techniques. However, internal features, such as interior flow passages in fuel injectors, can be difficult or impossible to surface finish using traditional techniques. Such flow passages typically require an appropriate level of surface finish in order to function as desired. This has been a limiting factor on application of additive manufacturing to components like fuel injectors and other items requiring surface finishing, especially for interior surfaces.

Such conventional methods and systems have generally been considered satisfactory for their intended purpose. However, there is still a need in the art for improved additive manufacture and surface finishing. The present disclosure provides a solution for this need.

### SUMMARY OF THE INVENTION

A method of additive manufacturing includes additively forming a workpiece. The workpiece defines an interior passage therethrough with a passage surface. Additively forming the workpiece includes additively forming a beam running through the interior passage spaced apart from the passage surface. The method also includes surface treating the passage surface using abrasive flow machining wherein an abrasive flow machining fluid is forced to flow between the beam and the passage surface.

The method can include removing the beam from the workpiece after surface treating the passage surface. Forming a beam running through the interior passage can include additively manufacturing the beam and workpiece with bridge structures suspending the beam in the interior passage. The method can include releasing the beam from the workpiece after surface treating by removing the bridge structures for removal of the beam from the interior passage.

Forming the beam can include forming the beam in the interior passage with a gap between the beam and passage surface that varies within the interior passage to concentrate surface treatment on a predetermined portion of the passage surface. The gap can varies axially along the interior passage. Forming the beam can include forming the beam with a bulge adjacent the predetermined portion of the passage surface.

The interior passage is a flow passage for a fluid, for example, a liquid. For example, it is contemplated that workpiece can include at least a portion of a fuel injector. The interior passage can be a liquid fuel passage of the fuel injector, an air passage of the fuel injector, and/or a gaseous fuel passage of the fuel injector.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a cross-sectional elevation view of an exemplary embodiment of a workpiece constructed in accordance with the present disclosure, showing the beam suspended within the interior passage of the workpiece;

FIG. 2 is a top end view of the workpiece of FIG. 1, showing the bridge structures suspending the beam within the interior passage;

FIG. 3 is a cross-sectional elevation view of another exemplary embodiment of a workpiece constructed in accordance with the present disclosure, showing a beam with a bulge for concentrating surface on a predetermined portion of the passage surface; and

FIG. 4 is cross-sectional elevation view of another exemplary embodiment of a workpiece constructed in accordance with the present disclosure, showing a beam and passage defined along an arbitrary path.

### DETAILED DESCRIPTION OF THE PREFERRED EMBODIMENTS

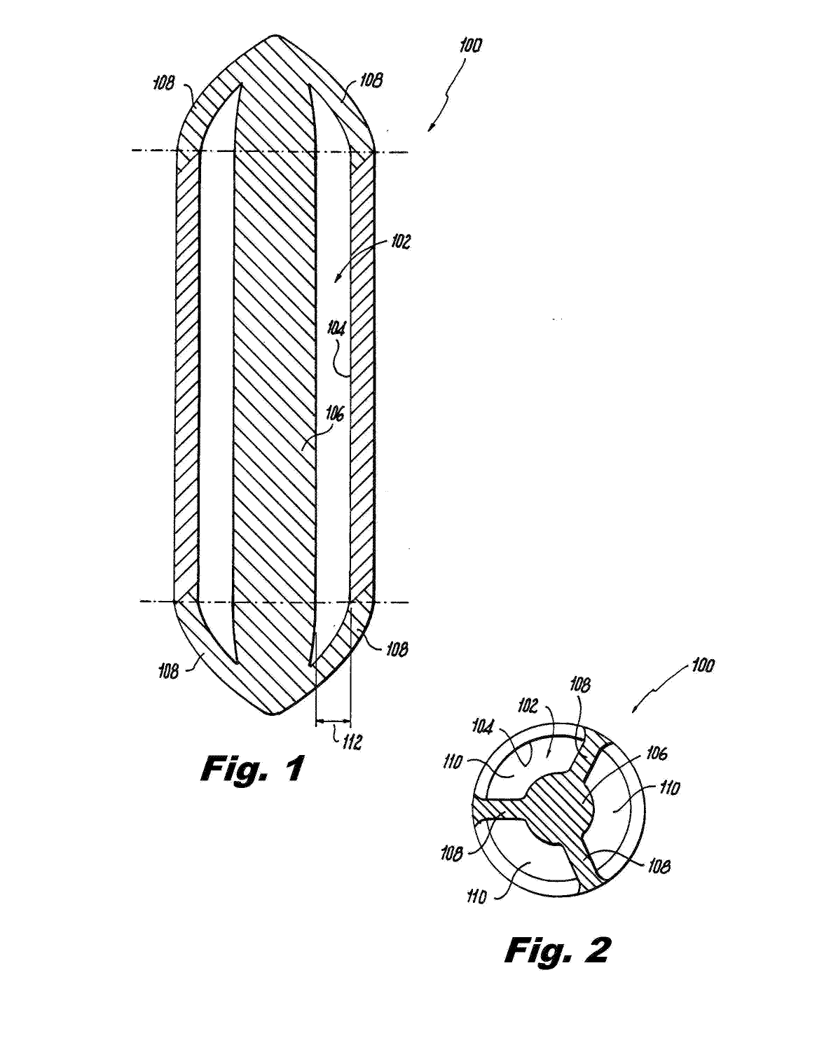

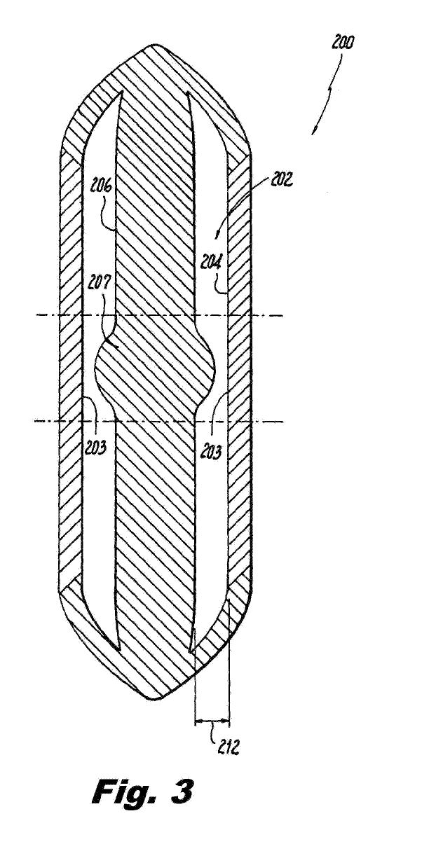

Reference will now be made to the drawings wherein like reference numerals identify similar structural features or aspects of the subject disclosure. For purposes of explanation and illustration, and not limitation, a partial view of an exemplary embodiment of a workpiece in accordance with the disclosure is shown in FIG. 1 and is designated generally by reference character 100. Other embodiments of workpieces in accordance with the disclosure, or aspects thereof, are provided in FIGS. 2-4, as will be described. The systems and methods described herein can be used to improve surface finish in interior passages of additive manufactured components relative to traditional techniques.

A method of additive manufacturing includes additively forming a workpiece 100. The workpiece defines an interior passage 102 therethrough with a passage surface 104. Additively forming the workpiece 100 includes additively forming a beam 106 running through the interior passage 104 spaced apart from the passage surface 104. The method also includes surface treating the passage surface 106 using abrasive flow machining wherein an abrasive flow machining fluid is forced to flow between the beam 106 and the passage surface 104. The beam 106 is a sacrificial structure, which can be removed from the workpiece 100 after surface treating passage surface 104. The cross-hatching in the Figures is indicative not of a difference in material per se, but as a schematic indication of the sacrificial versus the non-sacrificial portions of workpiece 100.

Forming the beam 106 running through the interior passage 102 includes additively manufacturing the beam 106 together with the rest of workpiece 100 wherein bridge structures 108 suspend the beam 106 in the interior passage 102. The method can include releasing the beam 106 from the workpiece 100 after surface treating by removing the bridge structures 108 for removal of the beam 106 from the interior passage 102. For example, the beam 106 and bridge structures 108 can be cut along the dashed lines indicated in FIG. 1, after which the remainder of the beam 106 can be removed from interior passage 102.

With reference to FIG. 2, openings 110 are defined circumferentially between the bridge structures 108 at the top of workpiece 100, and similar openings are provided circumferentially between the bridge structures 108 at the bottom of workpiece 100 as oriented in FIG. 1. Through the openings 110 in one end of the workpiece 100 abrasive flow machining fluid can be introduced under pressure into the interior passage 102, and through the openings 110 on the opposite end of workpiece 100, the abrasive flow machining fluid can escape the interior passage 102.

The presence of beam 106 within interior flow passage forces the abrasive flow machining fluid, which typically has a high degree of viscosity, like a putty, to come under pressure and increases the contact of the fluid with passage surface 104 compared to the contact that would occur without beam 106. Forming the beam 106 can include forming the beam 106 in the interior passage with a gap 112 between the beam 106 and passage surface 104 that is relatively constant in the example shown in FIG. 1, wherein the smaller the gap 112, the greater the pressure drop for the flow machining fluid, and the greater the degree of surface finish.

Referring now to FIG. 3, it is also contemplated that the gap can vary to target predetermined areas for heightened surface finish. The workpiece 200 includes an interior flow passage 202 bounded by a passage surface 204 with a beam 206 extending through the flow passage 202 axially much as described above with respect to workpiece 100. Beam 206 includes a bulge 207 within the interior passage 202 to concentrate surface treatment on a predetermined portion 203 of the passage surface 204. In FIG. 3, the predetermined portion 203 is adjacent the bulge 207, and is schematically indicated with dashed lines. Since the gap 212 varies axially along the interior passage 202, narrowing adjacent to bulge 207, the flow machining fluid undergoes the greatest pressure drop at the narrowest portion of the gap 212, giving the greatest surface finish to the predetermined portion 203 of passage surface 204.

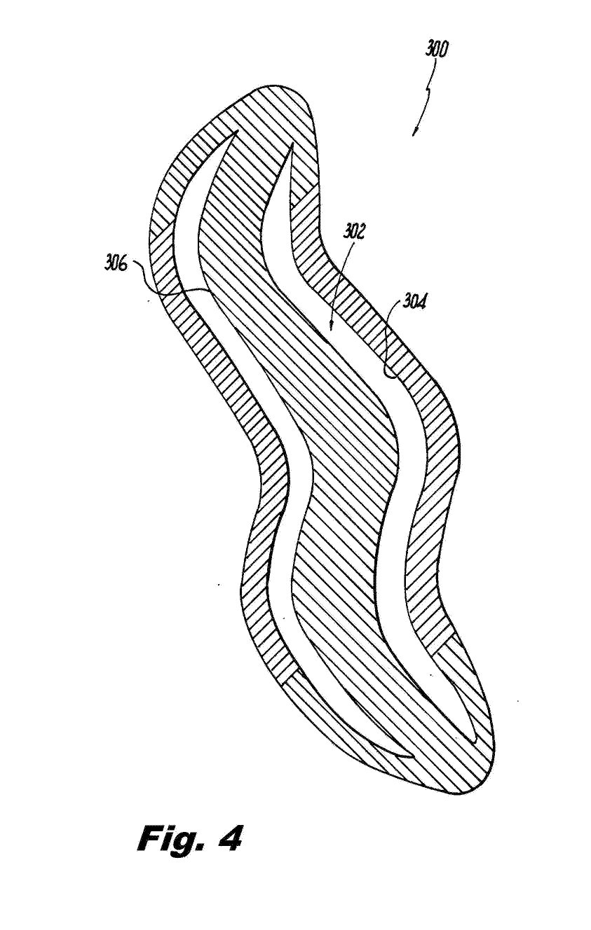

Bulge 207 is shown as being axisymmetric, however, those skilled in the art will readily appreciate that non-axisymmetric bulges can be used to target or control surface finish of non-axisymmetric portions of a passage surface as needed for particular applications. Those skilled in the art will readily appreciate that any suitable combination of narrowing the contour of passage surface 204 or widening beam 206 can be used to target portions of passage surface 204 for concentrated levels of surface finish. Moreover, those skilled in the art will readily appreciate that any suitable path can be followed by a workpiece, beam, passage surface, and interior passage without departing from the scope of this disclosure. For example, FIG. 4 shows an exemplary workpiece 300 with an interior passage 302 between a beam 306 and a passage surface 304 that follow an arbitrary path. The path in FIG. 4 is two dimensional only for sake of clarity, and those skilled in the art will readily appreciate that three-dimensional paths can also be used.

The interior passage can be a flow passage for a fluid, for example, a liquid or gas. For example, the systems and methods described herein can be applied to surface finish flow passage surfaces in pumps, housings, manifolds, heat exchangers, and the like. It is contemplated that the workpiece, e.g., workpiece 100, can include at least a portion of a fuel injector, for example. The interior passage, e.g., interior passage 102, can be a liquid fuel passage of the fuel injector, an air passage of the fuel injector, and/or a gaseous fuel passage of the fuel injector.

The methods and systems of the present disclosure, as described above and shown in the drawings, provide for additive manufacturing with superior properties including improved surface finish on interior features compared to conventional techniques. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of additive manufacturing comprising:
additively forming a workpiece, wherein the workpiece defines an interior passage therethrough with a passage surface, wherein additively forming the workpiece includes additively forming a beam running through the interior passage spaced apart from the passage surface; and
surface treating the passage surface using abrasive flow machining wherein an abrasive flow machining fluid is forced to flow between the beam and the passage surface.

2. A method as recited in claim 1, further comprising removing the beam from the workpiece after surface treating the passage surface.

3. A method as recited in claim 1, wherein forming a beam running through the interior passage includes additively manufacturing the beam and workpiece with bridge structures suspending the beam in the interior passage.

4. A method as recited in claim 3, further comprising releasing the beam from the workpiece after surface treating by removing the bridge structures for removal of the beam from the interior passage.

5. A method as recited in claim 1, wherein forming the beam includes forming the beam in the interior passage with a gap between the beam and passage surface that varies within the interior passage to concentrate surface treatment on a predetermined portion of the passage surface.

6. A method as recited in claim 5, wherein the gap varies axially along the interior passage.

7. A method as recited in claim 6, wherein forming the beam includes forming the beam with a bulge adjacent the predetermined portion of the passage surface.

8. A method as recited in claim 1, wherein the interior passage is a flow passage for a fluid.

9. A method as recited in claim 8, wherein the interior passage is a flow passage for a liquid.

10. A method as recited in claim 1, wherein the workpiece includes at least a portion of a fuel injector, and wherein the interior passage is a liquid fuel passage of the fuel injector.

11. A method as recited in claim 1, wherein the workpiece includes at least a portion of a fuel injector, and wherein the interior passage is an air passage of the fuel injector.

12. A method as recited in claim 1, wherein the workpiece includes at least a portion of a fuel injector, and wherein the interior passage is a gaseous fuel passage of the fuel injector.
